(19) United States
(12) Patent Application Publication
(10) Pub. No.: US 2024/0288282 A1
(43) Pub. Date: Aug. 29, 2024

(54) MODULAR MAPPING SYSTEM FOR GENERATION OF THREE-DIMENSIONAL MAPS FOR USE BY AUTONOMOUS VEHICLES

(71) Applicant: GM Cruise Holdings LLC, San Francisco, CA (US)

(72) Inventors: Marc Aboussouan, South Lake Tahoe, CA (US); David Houle, San Francisco, CA (US); Walter Condley, Berkeley, CA (US); Anthony Smith, San Francisco, CA (US); Nicholas Peterson, Madison, AL (US)

(21) Appl. No.: 18/175,938

(22) Filed: Feb. 28, 2023

(51) Int. Cl. G01C 21/00; H04N 23/90

(52) U.S. Cl. CPC G01C 21/3848; G01C 21/3837; H04N 23/90

(57) ABSTRACT

The disclosed technology provides solutions for generating three-dimensional maps for use by autonomous vehicles. A system of the disclosed technology may utilize a sensor assembly for supporting a plurality of sensors that is configured to be removably coupled to a roof of a vehicle, a server rack assembly that is configured to be removably coupled within a trunk of the vehicle, an encoder assembly that is configured to be removably coupled to a wheel of the vehicle, and a user interface that is configured to be removably coupled to a dash of the vehicle. The sensor assembly utilizes an integrally formed tubular member for supporting the plurality of sensors such that the sensors are fixed at precise predetermined distances from each other regardless of the type of vehicle used for generating the three-dimensional maps.

### BACKGROUND

### 1. Technical Field

The present disclosure generally relates to autonomous vehicles and, more specifically, relates to a modular mapping system for generating three-dimensional maps for use by autonomous vehicles.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Autonomous vehicles may also utilize previously collected mapping data to enable certain operations, such as navigation. The mapping data may be collected using dedicated mapping vehicles that are equipped with numerous sensors that are configured to capture the mapping data. Such sensors may be mounted on various regions of a particular mapping vehicle and thus are intended to remain with the vehicle and not be removable.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a block diagram of a modular mapping system for generating three-dimensional maps for use by autonomous vehicles, according to some examples of the present disclosure;

FIG. 2A illustrates a first perspective view of a sensor assembly, according to some examples of the present disclosure;

FIG. 2B illustrates a second perspective view of a sensor assembly, according to some examples of the present disclosure;

FIG. 3A illustrates a first perspective view of a camera assembly, according to some examples of the present disclosure;

FIG. 3B illustrates an exploded view of a camera assembly, according to some examples of the present disclosure;

FIG. 4 illustrates a perspective view of a server rack assembly, according to some examples of the present disclosure;

FIG. 5 illustrates a perspective view of a frame of a server rack assembly, according to some examples of the present disclosure; and

FIG. 6 illustrates an example processor-based system architecture for implementing certain aspects described herein.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

An autonomous vehicle (AV) is a motorized vehicle that can navigate without a human driver. An exemplary AV can include various sensors, such as a camera sensor, a light detection and ranging (LIDAR) sensor, and a radio detection and ranging (RADAR) sensor, amongst others. The sensors collect data and measurements that the AV can use for operations such as navigation. The sensors can provide the data and measurements to an internal computing system of the AV, which can use the data and measurements to control a mechanical system of the AV, such as a vehicle propulsion system, a braking system, or a steering system. AVs may also utilize previously collected mapping data to enable certain operations, such as navigation. The mapping data may be collected using dedicated mapping vehicles that are equipped with numerous sensors that are configured to capture the mapping data. Such sensors may be mounted on various regions of a particular mapping vehicle and thus are intended to remain with the vehicle and not be removable.

The disclosed technology provides for a modular mapping system that may be used with any vehicle to generate three-dimensional maps for use by AVs. The modular mapping system is configured to be removably coupled to any vehicle and maintain precise positioning of mapping sensors regardless of vehicle. As will be discussed in further detail below, a sensor mount is utilized to mount the mapping sensors thereon. The sensor mount is an integrally formed tubular structure having high rigidity and keying features to mount and position sensors thereon in a precise and repeatable manner. The sensor mount is configured to be removably coupled to a roof of a vehicle. The modular mapping kit also includes a server rack assembly that is configured to be removably coupled within a trunk of the vehicle, an encoder assembly that is configured to be removably coupled to a wheel of the vehicle, and a user interface that is configured to be removably coupled to a dash of the vehicle. As such, each component of the modular mapping system is designed to be removable and may be placed in any vehicle while maintaining crucial spacing of mapping sensors to enable gathering and collecting of quality data while maintaining flexibility. By utilizing a modular mapping system that is capable of being used on any vehicle, the mapping system may be shipped to locations of interest and mounted to any vehicle thereby enabling generation of three-dimensional maps in a more efficient manner without requiring extensive recalibration and time to manually position and adjust sensors.

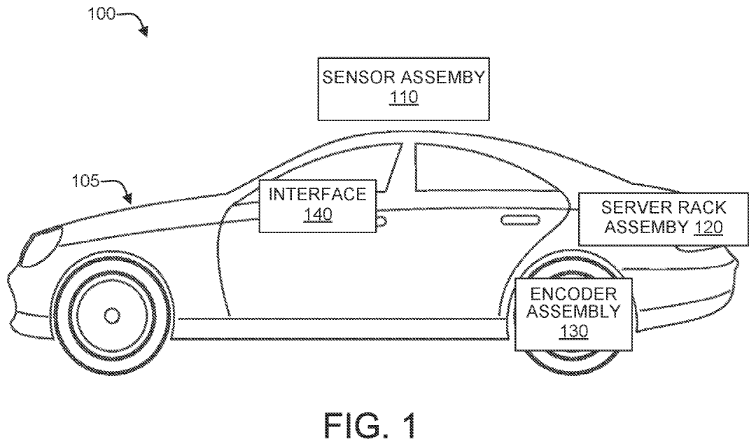

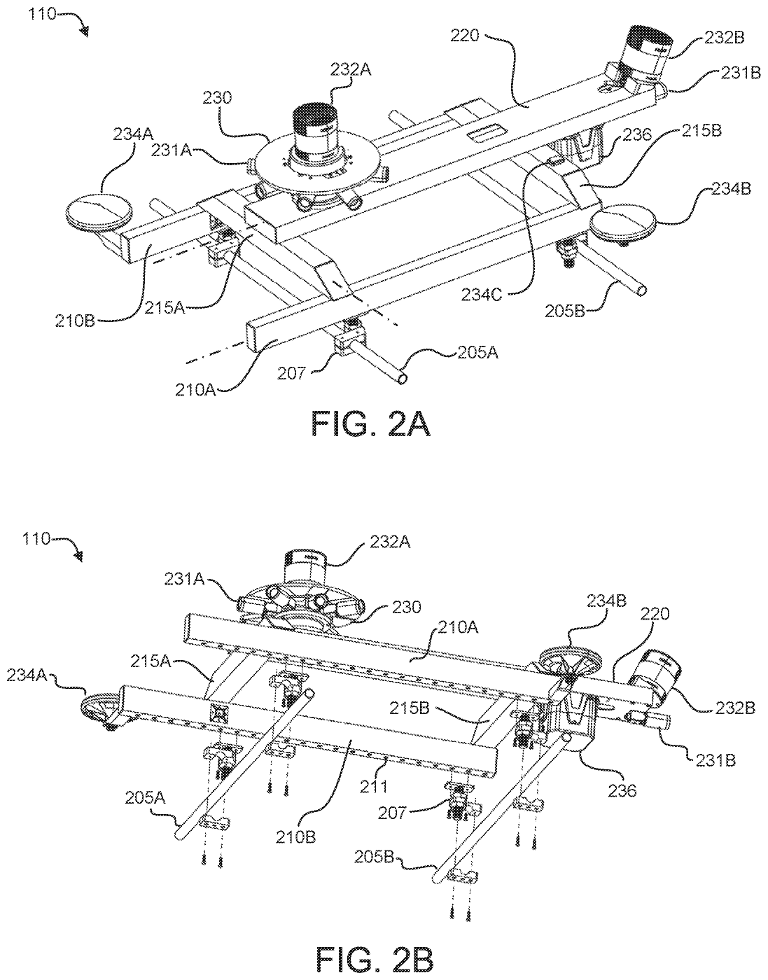

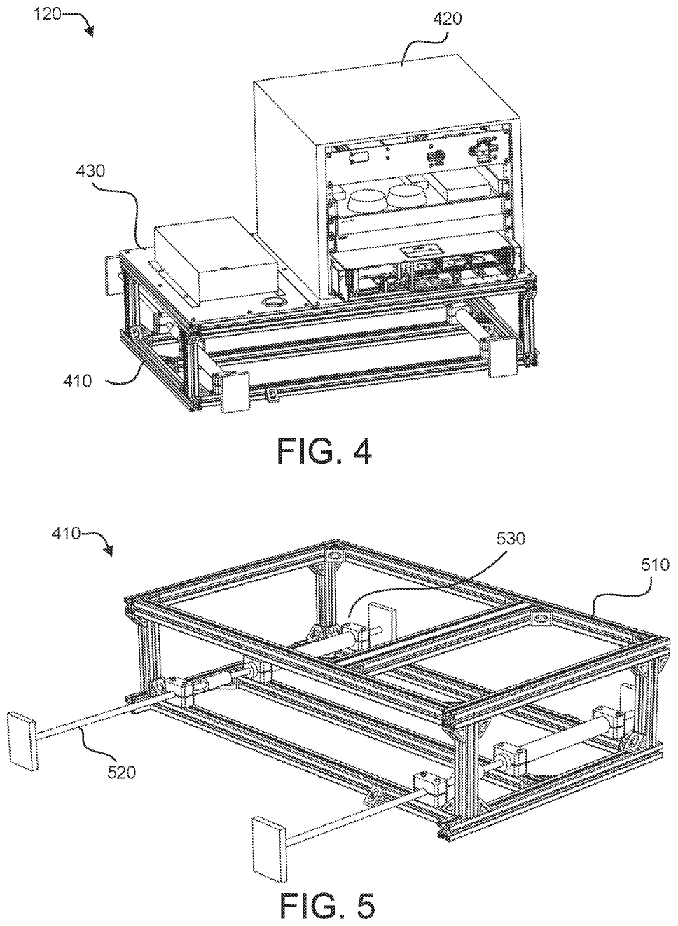

FIG. 1 illustrates a block diagram of a modular mapping system 100 for generating three-dimensional maps for use by autonomous vehicles, according to some examples of the present disclosure. The modular mapping system 100 includes a sensor assembly 110, a server rack assembly 120, an encoder assembly 130, and a user interface 140. The modular mapping system 100 is configured to be removably mounted to a vehicle 105. Specifically, the sensor assembly 110 is configured to be removably coupled to a roof of the vehicle 105 via the use of clamps coupled to a roof rack of the vehicle 105 (as shown in FIGS. 2A-2B), the server rack assembly 120 is configured to be removably coupled to an interior area of a trunk of the vehicle 105 via the use of adjustable jacks (as shown in FIGS. 4-5), the encoder assembly 130 is configured to be removably coupled to a wheel of the vehicle 105 via the use of hardware to couple to lugs of the wheel, and the user interface 140 is configured to be removably coupled to a dash of the vehicle 105 via the use of suction cups. The server rack assembly 120 is in communication and/or electrically coupled to the sensor assembly 110, encoder assembly 130, and user interface 140. The server rack assembly 120 is configured to receive data from the sensor assembly 110, encoder assembly 130, and the user interface 140 for processing. As will be discussed in further detail below, the sensor assembly 110 is configured to support a plurality of sensors that are configured to capture mapping data. The encoder assembly 130 is configured to capture vehicle movement data, including wheel slippage for processing by the server rack assembly 120. The user interface 140 is configured to enable a user to provide input to the mapping system 100 as well as display data from the mapping system 100 to enable certain operations of the modular mapping system 100 such as debugging and calibration.

In one aspect, the interface 140 may include a tablet computer that can be configured to display information and receive user input. In one example, the tablet may display maps and routes for the AV to traverse and may further provide real-time feedback as to which routes have been already been traversed and which routes the AV has not yet traversed. As such the tablet enables a user to efficiently monitor routes the system 100 has mapped in real-time.

The tablet may further be configured to enable sensor calibration and debugging. For example, the tablet may display real-time sensor data, real-time sensor status, data logs, and sensor parameters that may be adjusted via user input received via the tablet. In one example, the tablet may display an operational status of the components of the sensor assembly 110 by using, for example, colored indicators where green denotes proper operation and red denotes improper operation or error. Data logs may also be requested and displayed to show historical data captured by the sensor assembly 110. In another example, the tablet may display sensor data in real-time that enables a user to monitor and confirm operation of various sensors. In instances where a sensor is outputting data in real-time that appears incorrect, the user may perform debugging operations in real-time using the tablet to correct and address such errors. For instance, image data captured by one or more cameras in sensor assembly 110 may be viewed in real-time on the tablet and the image data may be assessed for quality. Should image data appear out of focus, the user may then adjust parameters of the corresponding sensor (e.g., camera) to improve image quality. Similarly, where parameters may be adjusted to improve image quality due to lighting conditions, the user may utilize the tablet to adjust exposure, brightness, or other image variables to optimize image quality in real-time.

In some aspects, interface 140 may display indicators that convey information about the operational status of one or more associated sensors, including sensors of different modalities. By way of example, the display indicators may include lighting indicators, such as one or more green light indicators to signify normal sensor operation of an associated sensor, and/or one or mor red light indicators to signify operational abnormalities.

FIGS. 2A and 2B illustrate perspective views of a sensor assembly 110, according to some examples of the present disclosure. The sensor assembly 110 includes a first support member 210A and a second support member 210B that are configured to removably couple to a roof rack of a vehicle. Specifically, the first and second support members, 210A and 210B respectively, include a plurality of holes 211 for receiving a mount 207 that couples to the roof rack of the vehicle. The plurality of holes 211 provide flexibility to mount to different roof rack configurations as may be present in different vehicles and further enable a position of the sensor assembly 110 to be adjusted, as desired, to reduce or eliminate interference of the sensor's field of view with the car. The roof rack may include a first rod 205A and a second rod 205B spaced apart from the first rod 205A. The mounts 207 are configured to couple the roof rack rods 205A, 205B to the first and second support members 210A, 210B. The sensor assembly 110 further includes a first cross member 215A and a second cross member 215B. The first and second cross members, 215A and 215B respectively, are rigidly coupled to the first and second support members, 210A and 210B respectively. The first and second support members, 210A and 210B respectively, may extend along a longitudinal direction with respect to the vehicle. The first and second cross members, 215A and 215B respectively, may extend along a lateral direction with respect to the vehicle.

The sensor assembly 110 further includes a sensor mount 220 for supporting a plurality of sensors. The sensor mount 220 extends across the first and second cross members, 215A and 215B respectively, and is rigidly coupled to the first and second cross members 215A, 215B. The sensor mount 220 is an integrally formed rigid tube having a closed cross section and may extend longitudinally with respect to the vehicle. The closed cross section may be rectangular, square, circular, or any other shape having a closed cross section. The sensor mount may be fabricated from metal, a metal alloy, composite, or other rigid and structural material that is capable of being machined for precise placement of keying features, such as dowels and holes.

The sensor mount 220 is configured to support the sensors necessary for generating a three-dimensional map. Such sensors may include cameras, LIDAR, and an inertial measurement unit (IMU). Specifically, the sensors mounted onto the sensor mount 220 includes a camera assembly 230 having a plurality of cameras 231A, a rear camera 231B, a first LIDAR 232A, a second LIDAR 232B, and an IMU 236. Cameras may be configured to capture still image cameras and/or video. While LIDAR is specifically identified, it is understood that other types of sensors may be used, such as ambient light sensors, infrared sensors, RADAR systems, Sound Navigation and Ranging (SONAR) systems, ultrasonic sensors, and so forth.

The camera assembly 230 is mounted on a top surface of the sensor mount 220 at a proximal portion of the sensor mount. The camera assembly 230 is configured to capture a full 360-degree view of the area surrounding the vehicle. The first LIDAR 232A is mounted atop of the camera assembly 230 at the proximal portion of the sensor mount 220. The second LIDAR 232B is mounted to the sensor mount 220 at a distal portion of the sensor mount 220. The first and second LIDARS 232A, 232B are configured to capture a full 360-degree view of the area surrounding the vehicle. The IMU 236 is mounted on a bottom surface of the sensor mount 220 opposite the top surface such that the IMU 236 is disposed outside of a field of view of the camera assembly 230. The IMU 236 is configured to capture accelerometer data. The rear camera 231B is mounted on the bottom surface of the sensor mount 220 at the distal portion of the sensor mount 220.

In one aspect, the first LIDAR 232A is disposed on a horizontal plane that is parallel to the top surface of the sensor mount 220 and the second LIDAR 232B is mounted at an angle with respect to the horizontal plane. By orientating the first LIDAR 232A so that it is disposed on a plane above the second LIDAR 232B, interference is minimized. In addition, by angling the second LIDAR 232B at an angle, data regarding the roadway is better captured.

In another aspect, by mounting the IMU 236 on the same rigid structure as the camera assembly 230, the first LIDAR 232A, and the second LIDAR 232B, correlation of data captured by each component is improved by minimizing any impact vehicle flexure may have on such components. In other words, by co-locating the sensors onto the sensor mount 220, each experiences the same dynamic loads thereby improving the quality of the captured data regardless of whether the vehicle traverses a speed bump, pothole, or engages in driving operations that may generate high acceleration such as by making a U-turn. In addition, by utilizing the sensor mount 220 to mount such components, placement of the camera assembly 230, rear camera 231B, first LIDAR 232A, second LIDAR 232B, and IMU 236 may be precisely controlled and positioning of each component with respect to one another may be easily repeatedly obtained through the use of keying features, such as dowels and mounting holes that are machined into the sensor mount. By maintaining the precise positioning of each component on the sensor mount, the quality of captured data is improved and may be maintained regardless of the type of vehicle used to capture the mapping data. The use of keying features (e.g., mounting holes, dowels, etc.) also enables quick interchangeability of sensors in the event a component fails or otherwise requires replacement.

The sensor assembly 110 may also include a first GPS antenna 234A, a second GPS antenna 234B, and a third GPS antenna 234C. The first GPS antenna 234A may be disposed on a proximal portion of the second support member 210B. The second GPS antenna 234B may be disposed on a distal portion of the first support member 210A. The third GPS antenna 234C may be disposed on the second cross member 215B. The first and second GPS antennas 234A, B provide data to enable the determination of the vehicle's location. The third GPS antenna 234C may be used to synchronize and timestamp data captured by the cameras, LIDAR, and/or IMU.

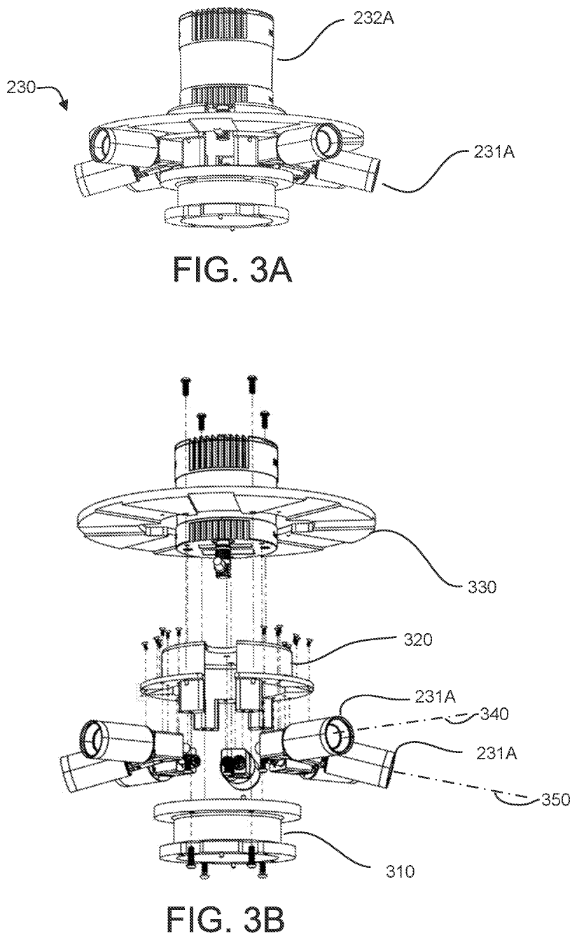

FIGS. 3A and 3B illustrate perspective views of a camera assembly 230, according to some examples of the present disclosure. The camera assembly 230 includes a plurality of cameras 231A arranged in circular arrangement. In one example, there may be seven cameras 231A arranged along a circular pattern. In one aspect, a subset of the plurality of cameras may be angled on a different plane than the other cameras of the plurality of cameras. For example, cameras 231A facing along a side (e.g., right, left) of the vehicle may be angled downward along an angled axis 350, whereas cameras 231A facing forward or rearward may not be angled downward and instead may be directed along a horizontal axis 340. The camera assembly 230 also includes a standoff 310 to raise the cameras 231A at a height that enables a clear field of view of the area surrounding the vehicle, a bracket 320 that enables positioning of the cameras 231A in a circular pattern at a desired spacing, and a cover 330 that protects the cameras 231A from direct sunlight or other environmental elements.

FIG. 4 illustrates a perspective view of a server rack assembly 120, according to some examples of the present disclosure. The server rack assembly 120 includes a frame 410, computing assembly 420, and a power assembly 430. The computing assembly 420 is configured to sync and capture the data provided by the encoder assembly 130, and the components of the sensor assembly 110 including the IMU 236, camera assembly 230, rear camera 231B, LIDARs 232A-B, and GPS antennas 234A-C. The computing assembly 420 also includes a network switch, transfer switch, gateway, and computing processors. The power assembly 430 is configured to provide power to the computing assembly 420 and may provide power to other components of the modular mapping system 100.

The server rack assembly 120 may utilize a network to communicate with the sensor assembly 110, encoder assembly 130, and interface 140. The network may be a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.). Communication between the components of the modular mapping system 100 may be provided by a WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Data may also be exchanged through a wired connection (e.g., via Universal Serial Bus (USB), etc.).

FIG. 5 illustrates a perspective view of a frame 410 of a server rack assembly 120, according to some examples of the present disclosure. The frame 410 includes interconnected members 510, a plurality of adjustable jacks 520 configured for removably coupling the server rack assembly 120 to an interior area of a trunk of the vehicle, and mounts 530 to couple the adjustable jacks 520 to the interconnected members 510. The adjustable jacks are configured to extend such that they engage an inner surface of the trunk, thereby securing the server rack assembly 120 within a trunk of the vehicle.

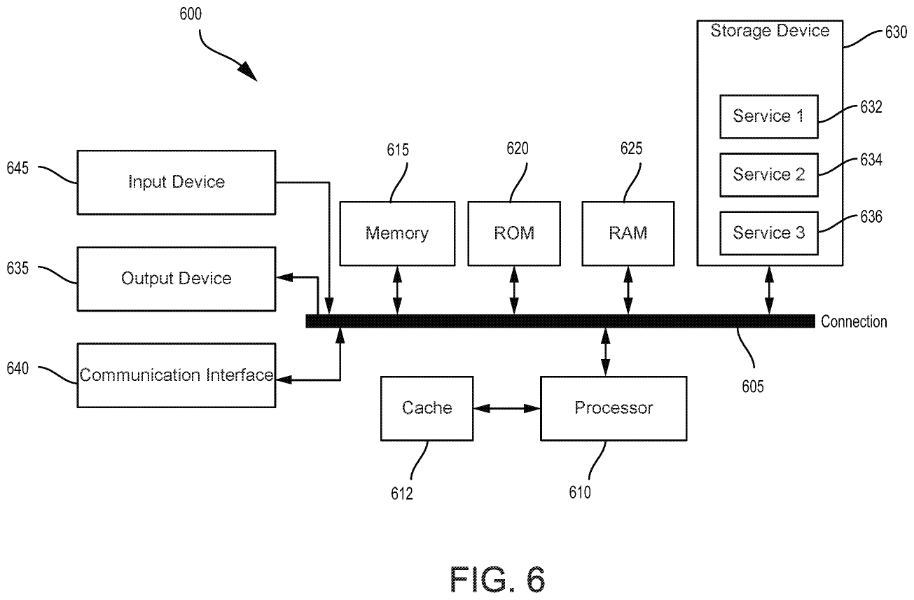

FIG. 6 illustrates an example processor-based system architecture for implementing certain aspects described herein. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Illustrative examples of the disclosure include:

Aspect 1. A modular mapping system comprising: a first support member and a second support member, the first and second support members configured to removably couple to a roof of a vehicle; a first cross member and a second cross member, the first and second cross members rigidly coupled to the first and second support members; a sensor mount rigidly coupled to the first and second cross members, the sensor mount configured to support a plurality of sensors, the plurality of sensors comprising a camera assembly, a first LIDAR, a second LIDAR, and an inertial measurement unit (IMU); wherein the camera assembly is mounted on a top surface of the sensor mount at a proximal portion of the sensor mount; wherein the first LIDAR is mounted atop of the camera assembly at the proximal portion of the sensor mount; wherein the second LIDAR is mounted to the sensor mount at a distal portion of the sensor mount; and wherein the IMU is mounted on a bottom surface of the sensor mount opposite the top surface such that the IMU is disposed outside of a field of view of the camera assembly.

Aspect 2. The modular mapping system of Aspect 1, further comprising a first GPS antenna disposed on a proximal portion of the second support member and a second GPS antenna disposed on a distal portion of the first support member.

Aspect 3. The modular mapping system of any of Aspects 1 or 2, further comprising a third GPS antenna disposed on the second cross member.

Aspect 4. The modular mapping system of any of Aspects 1 to 3, further comprising a second camera mounted to the sensor mount at the distal portion of the sensor mount.

Aspect 5. The modular mapping system of any of Aspects 1 to 4, further comprising a server rack assembly, the server rack assembly including a plurality of adjustable jacks configured to secure the server rack assembly within a trunk of the vehicle, the server rack assembly in communication with the plurality of sensors.

Aspect 6. The modular mapping system of any of Aspects 1 to 5, further comprising an encoder assembly, the encoder assembly configured to couple to a wheel of the vehicle and in communication with the server rack assembly.

Aspect 7. The modular mapping system of any of Aspects 1 to 6, further comprising a user interface, the user interface configured to couple to a dash of the vehicle and in communication with the server rack.

Aspect 8. The modular mapping system of any of Aspects 1 to 7, wherein the camera assembly comprises a plurality of cameras arranged in circular arrangement, wherein a subset of the plurality of cameras are angled on a different plane than the other cameras of the plurality of cameras.

Aspect 9. The modular mapping system of any of Aspects 1 to 8, wherein the first LIDAR is disposed on a horizontal plane that is parallel to the top surface of the sensor mount and the second LIDAR is mounted at an angle with respect to the horizontal plane.

Aspect 10. The modular mapping system of any of Aspects 1 to 9, wherein first and second support members include a plurality of holes for coupling to the roof of the vehicle.

Aspect 11. The modular mapping system of any of Aspects 1 to 10, wherein sensor mount comprises an integrally formed tube having a closed cross section.

Aspect 12. The modular mapping system of any of Aspects 1 to 11, wherein the first and second support members extend along a longitudinal direction with respect to the vehicle.

Aspect 13. The modular mapping system of any of Aspects 1 to 12, wherein the first and second cross members extend along a lateral direction with respect to the vehicle.

Aspect 14. A sensor mount for generation of a three-dimensional map for use by autonomous vehicles, the sensor mount comprising: a tubular member extending along a longitudinal axis, the tubular member having a closed cross section; a camera assembly mounted on a top surface of the tubular member at a proximal portion of the tubular member; a first LIDAR mounted atop of the camera assembly at the proximal portion of the tubular member; a second LIDAR mounted on the top surface of the tubular member at a distal portion of the tubular member; and an IMU mounted on a bottom surface of the tubular member, the bottom surface located opposite the top surface; wherein the IMU is disposed outside of a field of view of the camera assembly.

Aspect 15. The sensor mount of Aspect 14, further comprising a second camera mounted on the bottom surface of the tubular member at the distal portion of the tubular member.

Aspect 16. The sensor mount of any of Aspects 14 or 15, wherein the camera assembly comprises a plurality of cameras arranged in circular arrangement, wherein a subset of the plurality of cameras are angled on a different plane than the other cameras of the plurality of cameras.

Aspect 17. The sensor mount of any of Aspects 14 to 16, wherein the first LIDAR is disposed on a horizontal plane that is parallel to the top surface of the tubular member and the second LIDAR is mounted at an angle with respect to the horizontal plane.

Aspect 18. A modular mapping kit for generation of a three-dimensional map for use by autonomous vehicles, the modular mapping kit comprising: a sensor assembly, wherein the sensor assembly includes a tubular member extending along a longitudinal axis for supporting a plurality of sensors, the plurality of sensors comprising a camera assembly, a first LIDAR, a second LIDAR, and an IMU, the sensor assembly configured to be removably coupled to a roof of a vehicle; a server rack assembly, wherein the server rack assembly includes a plurality of adjustable jacks configured for removably coupling the server rack assembly to an interior area of a trunk of the vehicle, the server rack assembly configured to be in communication with the plurality of sensors; an encoder assembly, wherein the encoder assembly is configured to be removably coupled to a wheel of the vehicle and is further configured to be in communication with the server rack assembly; and a user interface, wherein the user interface is configured to be removably coupled to a dash of the vehicle and is further configured to be in communication with the server rack.

Aspect 19. The modular mapping kit of Aspect 18, wherein the sensor assembly further comprises a first GPS antenna, a second GPS antenna, and a second camera.

Aspect 20. The modular mapping kit of any of Aspects 18 or 19, wherein the camera assembly is mounted on a top surface of the tubular member at a proximal portion of the tubular member; wherein the first LIDAR is mounted atop of the camera assembly at the proximal portion of the tubular member; wherein the second LIDAR is mounted on the top surface of the tubular member at a distal portion of the tubular member; and wherein the IMU is mounted on a bottom surface of the tubular member opposite the top surface such that the IMU is disposed outside of a field of view of the camera assembly.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A modular mapping system comprising:
a first support member and a second support member, the first and second support members configured to removably couple to a roof of a vehicle;
a first cross member and a second cross member, the first and second cross members rigidly coupled to the first and second support members;
a sensor mount rigidly coupled to the first and second cross members, the sensor mount configured to support a plurality of sensors, the plurality of sensors comprising a camera assembly, a first LIDAR, a second LIDAR, and an inertial measurement unit (IMU);
wherein the camera assembly is mounted on a top surface of the sensor mount at a proximal portion of the sensor mount;
wherein the first LIDAR is mounted atop of the camera assembly at the proximal portion of the sensor mount;
wherein the second LIDAR is mounted to the sensor mount at a distal portion of the sensor mount; and
wherein the IMU is mounted on a bottom surface of the sensor mount opposite the top surface such that the IMU is disposed outside of a field of view of the camera assembly.

2. The modular mapping system of claim 1, further comprising a first GPS antenna disposed on a proximal portion of the second support member and a second GPS antenna disposed on a distal portion of the first support member.

3. The modular mapping system of claim 2, further comprising a third GPS antenna disposed on the second cross member.

4. The modular mapping system of claim 1, further comprising a second camera mounted to the sensor mount at the distal portion of the sensor mount.

5. The modular mapping system of claim 1, further comprising a server rack assembly, the server rack assembly including a plurality of adjustable jacks configured to secure the server rack assembly within a trunk of the vehicle, the server rack assembly in communication with the plurality of sensors.

6. The modular mapping system of claim 5, further comprising an encoder assembly, the encoder assembly configured to couple to a wheel of the vehicle and in communication with the server rack assembly.

7. The modular mapping system of claim 6, further comprising a user interface, the user interface configured to couple to a dash of the vehicle and in communication with the server rack.

8. The modular mapping system of claim 1, wherein the camera assembly comprises a plurality of cameras arranged in circular arrangement, wherein a subset of the plurality of cameras are angled on a different plane than the other cameras of the plurality of cameras.

9. The modular mapping system of claim 1, wherein the first LIDAR is disposed on a horizontal plane that is parallel to the top surface of the sensor mount and the second LIDAR is mounted at an angle with respect to the horizontal plane.

10. The modular mapping system of claim 1, wherein first and second support members include a plurality of holes for receiving mounts for adjustably coupling to the roof of the vehicle.

11. The modular mapping system of claim 1, wherein sensor mount comprises an integrally formed tube having a closed cross section.

12. The modular mapping system of claim 1, wherein the first and second support members extend along a longitudinal direction with respect to the vehicle.

13. The modular mapping system of claim 12, wherein the first and second cross members extend along a lateral direction with respect to the vehicle.

14. A sensor mount for generation of a three-dimensional map for use by autonomous vehicles, the sensor mount comprising:
a tubular member extending along a longitudinal axis, the tubular member having a closed cross section;
a camera assembly mounted on a top surface of the tubular member at a proximal portion of the tubular member;
a first LIDAR mounted atop of the camera assembly at the proximal portion of the tubular member;
a second LIDAR mounted on the top surface of the tubular member at a distal portion of the tubular member; and
an IMU mounted on a bottom surface of the tubular member, the bottom surface located opposite the top surface; wherein the IMU is disposed outside of a field of view of the camera assembly.

15. The sensor mount of claim 14, further comprising a second camera mounted on the bottom surface of the tubular member at the distal portion of the tubular member.

16. The sensor mount of claim 14, wherein the camera assembly comprises a plurality of cameras arranged in circular arrangement, wherein a subset of the plurality of cameras are angled on a different plane than the other cameras of the plurality of cameras.

17. The sensor mount of claim 14, wherein the first LIDAR is disposed on a horizontal plane that is parallel to the top surface of the tubular member and the second LIDAR is mounted at an angle with respect to the horizontal plane.

18. A modular mapping kit for generation of a three-dimensional map for use by autonomous vehicles, the modular mapping kit comprising:
a sensor assembly, wherein the sensor assembly includes a tubular member extending along a longitudinal axis for supporting a plurality of sensors, the plurality of sensors comprising a camera assembly, a first LIDAR, a second LIDAR, and an IMU, the sensor assembly configured to be removably coupled to a roof of a vehicle;
a server rack assembly, wherein the server rack assembly includes a plurality of adjustable jacks configured for removably coupling the server rack assembly to an interior area of a trunk of the vehicle, the server rack assembly configured to be in communication with the plurality of sensors;
an encoder assembly, wherein the encoder assembly is configured to be removably coupled to a wheel of the vehicle and is further configured to be in communication with the server rack assembly; and
a user interface, wherein the user interface is configured to be removably coupled to a dash of the vehicle and is further configured to be in communication with the server rack.

19. The modular mapping kit of claim 18, wherein the sensor assembly further comprises a first GPS antenna, a second GPS antenna, and a second camera.

20. The modular mapping kit of claim 18, wherein the camera assembly is mounted on a top surface of the tubular member at a proximal portion of the tubular member; wherein the first LIDAR is mounted atop of the camera assembly at the proximal portion of the tubular member; wherein the second LIDAR is mounted on the top surface of the tubular member at a distal portion of the tubular member; and wherein the IMU is mounted on a bottom surface of the tubular member opposite the top surface such that the IMU is disposed outside of a field of view of the camera assembly.
